(19) United States
(12) Patent Application Publication
(10) Pub. No.: US 2024/0170206 A1
(43) Pub. Date: May 23, 2024

(54) METHOD FOR PRODUCING R-T-B BASED SINTERED MAGNET

(71) Applicant: PROTERIAL, LTD., Tokyo (JP)

(72) Inventors: Kouta SAITOU, Tokyo (JP); Futoshi KUNIYOSHI, Tokyo (JP)

(21) Appl. No.: 18/284,308

(22) PCT Filed: Feb. 24, 2022
(86) PCT No.: PCT/JP2022/007631

§ 371 Date: Sep. 27, 2023

(30) Foreign Application Priority Data
Mar. 29, 2021 (JP) 2021-054568

(51) Int. Cl. H01F 41/02; B22F 3/16; B22F 9/02; B22F 9/04; C22C 38/00; C22C 38/06; C22C 38/10; C22C 38/14; C22C 38/16; H01F 1/057

(52) U.S. Cl. CPC H01F 41/0253; B22F 3/16; B22F 9/023; B22F 9/04; C22C 38/001; C22C 38/002; C22C 38/005; C22C 38/06; C22C 38/10; C22C 38/14; C22C 38/16; B22F 2009/044; B22F 2202/05; B22F 2301/355; B22F 2304/10; B22F 2998/10; B22F 2999/00; C22C 2202/02; H01F 1/0577

(57) ABSTRACT

A method for producing an R-T-B-based sintered magnet comprises a sintering step for sintering a shaped product of R-T-B-based alloy powder. This sintering step includes: a first step for heating the shaped product at a first sintering temperature T1 to prepare a first sintered body; a cooling step for lowering the temperature of the first sintered body to a cooling temperature T0; and a second step for heating the first sintered body at a second sintering temperature T2 to prepare a second sintered body. The first sintering temperature T1 and the second sintering temperature T2 are higher than 900° C., and the cooling temperature T0 is 900° C. or lower. A first sintering time t1 for which the first sintering temperature T1 is maintained in the first step is shorter than a second sintering time t2 for which the second sintering temperature T2 is maintained in the second step.

### TECHNICAL FIELD

The present application relates to a method for producing a sintered R-T-B based magnet.

### BACKGROUND ART

Sintered R-T-B based magnets (where R is a rare-earth element and contains at least one selected from the group consisting of Nd, Pr and Ce with no exception; T is at least one transition metal and contains Fe with no exception; and B is boron) each include a main phase formed of a compound having an R₂Fe₁₄B-type crystal structure, a grain boundary phase at grain boundaries of the main phase, and a compound phase generated by an influence of trace amount of elements incorporated thereto or impurities. The sintered R-T-B based magnets exhibit high remanence Bᵣ (hereinafter, may be referred to simply as “Bᵣ”) and high coercivity H_{cJ} (hereinafter, may be referred to simply as “H_{cJ}”), and thus are known as magnets of highest performance among permanent magnets. Therefore, the sintered R-T-B based magnets are used for various uses including various types of motors such as voice coil motors (VCM) of hard disc drives, motors for electric vehicles (EV, HV, PHV) and motors for industrial equipment, home appliance products, and the like. The sintered R-T-B based magnets decrease the size and the weight of various types of motors and the like, and thus contribute to energy savings and environmental load reduction.

Such a sintered R-T-B based magnet is produced by a method including a step of preparing an alloy powder, a step of pressing the alloy powder to form a compact, a step of sintering the compact, and the like.

Patent Document 1 discloses one example of such sintered R-T-B based magnets.

### CITATION LIST

### Patent Literature

Patent Document 1: WO2013/008756

### SUMMARY OF INVENTION

### Technical Problem

Recently, development of the materials for the sintered R-T-B based magnets and improvement in the methods for producing the sintered R-T-B based magnets have increased the H_{cJ} and the squareness ratio (Hₖ/H_{cJ}). However, there are cases where the H_{cJ} and the squareness ratio (Hₖ/H_{cJ}) are unexpectedly decreased by dispersion in the composition and the production conditions. As a result of the investigations performed by the present inventors, it has been found out that such a decrease in the H_{cJ} and the Hₖ/H_{cJ} is especially conspicuous in the case where the composition ratio of B (boron) contained in a sintered R-T-B based magnet is low as described in Patent Document 1.

Embodiments of the present disclosure provide a method for producing a sintered R-T-B based magnet capable of solving such a problem.

### Solution to Problem

In an example embodiment, a method for producing a sintered R-T-B based magnet according to the present disclosure includes a sintering step of sintering a compact of an R-T-B based alloy powder. The sintering step includes a first-stage step of heating the compact to a first sintering temperature T1 to form a first-stage sintered body, a cooling step of decreasing the temperature of the first-stage sintered body to a cooling temperature T0, and a second-stage step of heating the first-stage sintered body to a second sintering temperature T2 to form a second-stage sintered body. The first sintering temperature T1 and the second sintering temperature T2 are higher than 900° C. The cooling temperature T0 is not higher than 900° C. A first sintering time t1, for which the first sintering temperature T1 is maintained in the first-stage step, is shorter than a second sintering time t2, for which the second sintering temperature T2 is maintained in the second-stage step.

In an embodiment, the first sintering temperature T1 and the second sintering temperature T2 are not lower than 1000° C. and not higher than 1100° C.

In an embodiment, the first sintering temperature T1 is not lower than 1040° C. and lower than 1080° C., and the second sintering temperature T2 is not lower than 1020° C. and lower than 1060° C.

In an embodiment, the first sintering time t1 is not shorter than 30 minutes and not longer than 2 hours, and the second sintering time t2 is not shorter than 1 hour and not longer than 15 hours.

In an embodiment, the first sintering time t1 is not longer than a half of the second sintering time t2.

In an embodiment, the cooling temperature T0 is not lower than 700° C. and is not higher than 900° C.

In an embodiment, the alloy powder has a composition containing R at a content not lower than 28% by mass and not higher than 35% by mass, B at a content not lower than 0.8% by mass and not higher than 1.20% by mass, T at a content not lower than 61.5% by mass, and satisfying 14[B]/10.8<[T]/55.85 where [B] is a content of B represented with % by mass and [T] is a content of T represented with % by mass.

### Advantageous Effects of Invention

According to embodiments of the present disclosure, a method for producing a sintered R-T-B based magnet capable of realizing high H_{cJ} and high Hₖ/H_{cJ} is provided.

### BRIEF DESCRIPTION OF DRAWINGS

FIG. 1 is a flowchart showing a sintering step according to the present disclosure.

FIG. 2 schematically shows an example of temperature profile of heat treatment targets (compact and sintered body) in the sintering step in an embodiment.

FIG. 3 is schematically shows another example of temperature profile of the heat treatment targets (compact and sintered body) in the sintering step in the embodiment.

FIG. 4 is schematically shows still another example of temperature profile of the heat treatment targets (compact and sintered body) in the sintering step in the embodiment.

FIG. 5 is schematically shows yet another example of temperature profile of the heat treatment targets (compact and sintered body) in the sintering step in the embodiment.

### DESCRIPTION OF EMBODIMENTS

Hereinafter, an embodiment of a method for producing a sintered R-T-B based magnet according to the present disclosure will be described.

Regarding a sintered R-T-B based magnet in this embodiment, R is a rare-earth element and contains at least one selected from the group consisting of Nd, Pr and Ce with no exception. T is at least one transition metal and contains Fe with no exception.

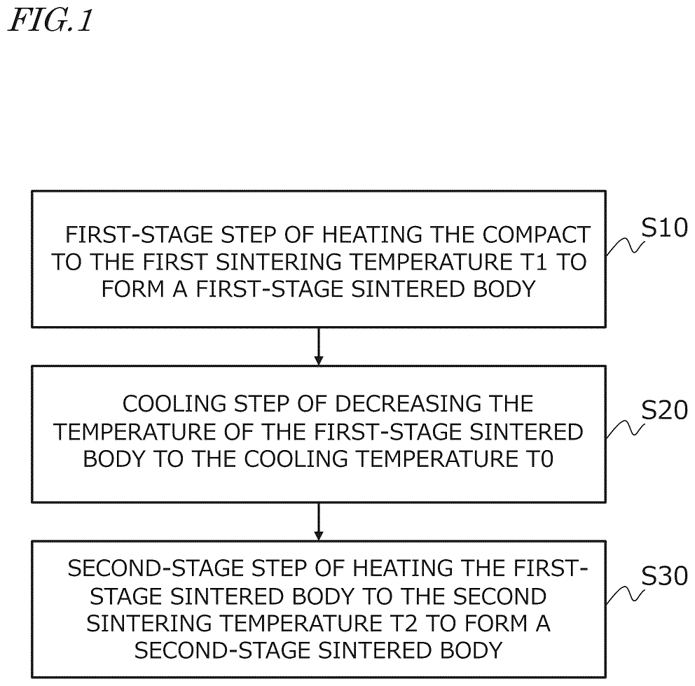

As shown in FIG. 1, the method for producing a sintered R-T-B based magnet in this embodiment includes:
a first-stage step (S10) of heating a compact to a first sintering temperature T1 to form a first-stage sintered body;
a cooling step (S20) of cooling the first-stage sintered body to a cooling temperature T0; and
a second-stage step (S30) of heating the first-stage sintered body to a second sintering temperature T2 to form a second-stage sintered body.

Herein, the first sintering temperature T1 and the second sintering temperature T2 are higher than 900° C., and the cooling temperature T0 is not higher than 900° C. A first sintering time t1, for which the first sintering temperature T1 is maintained in the first-stage step, is shorter than a second sintering time t2, for which the second sintering temperature T2 is maintained in the second-stage step.

A sintered R-T-B based magnet includes crystal grains of an Nd₂Fe₁₄B phase (ferromagnetic) as a main phase and an intermetallic compound, such as a B-rich phase rich in boron (B), an Nd-rich phase or the like, located at boundaries of the crystal grains of the main phase. A sintering reaction is caused to proceed by generation of a liquid phase that is contained in powder particles forming the compact and involves such a phase. On a stage where the amount of the liquid phase is insufficient, a reaction of generating a dense texture does not occur. As the amount of the liquid phase increases along with the increase in the temperature, the reaction of generating a dense texture proceeds rapidly. The liquid phase, which is generated by a part of the intermetallic compound in the powder particles being melted during the sintering, modifies surfaces of the crystal grains of the main phase or reduces an oxide, while the grains are bound and become dense progressively.

According to the research conducted by the present inventors, H_{cJ} and H,/H_{cJ} may occasionally be decreased unexpectedly due to variations or dispersion in the composition of an alloy powder and in the production conditions. It has also been found out that this phenomenon is conspicuous in the case where the composition ratio of B contained in the sintered R-T-B based magnet is low. It is difficult to avoid the dispersion in the composition of the alloy powder and in the production conditions. Therefore, it is required to realize high H_{cJ} and high Hₖ/H_{cJ} even when there is dispersion in the composition of the alloy powder and in the production conditions. In order to realize high H_{cJ} and high Hₖ/H_{cJ}, it is needed to perform sintering such that the resultant crystal texture has a desired density and is uniform. Conventionally, in order to realize a dense and uniform crystal texture even when there is dispersion in the composition of the alloy powder and in the production conditions, the sintering time is set to be long (for example, 25 hours). However, this extends the sintering time and deteriorates the mass-productivity. In the case where the sintering step is performed at a lower sintering temperature in an attempt to prevent the deterioration in the mass-productivity, the crystal grains exhibit abnormal growth, which may possibly deteriorate the magnetic characteristics rapidly. Therefore, the sintering needs to be performed so as to avoid the abnormal growth of the crystal grains. As a result of investigations, the present inventors have found out that the optimal sintering conditions to obtain a dense and uniform crystal texture vary. The present inventors made further investigations based on such knowledge, and as a result, have found out the following. In the case where the compact is sintered in a relatively short time (first-stage step) to promote formation of a dense texture, then is cooled to a predetermined temperature and then is further sintered (second-stage step), a dense and uniform crystal texture is realized even when there is dispersion in the composition of the alloy powder and in the production conditions. In this manner, a sintered magnet having high H_{cJ} and high Hₖ/H_{cJ} is provided without the sintering being performed for a long time.

In the field of sintered R-T-B based magnets, Hₖ, which is one of the parameters defining Hₖ/H_{cJ}, is generally determined as follows. Regarding the second orthant of the J-H curve, where the intensity of magnetization is J, the residual magnetization is Jᵣ (=B), and the intensity of the magnetic field is H, the reading on the H axis of the position at which J has a value of 0.9×Jᵣ is used. A value of Hₖ divided by H_{cJ} of the demagnetization curve, namely, Hₖ/H_{cJ}=Hₖ(kA/m)/H_{cJ} (kA/m)×100(%) is defined as the squareness ratio.

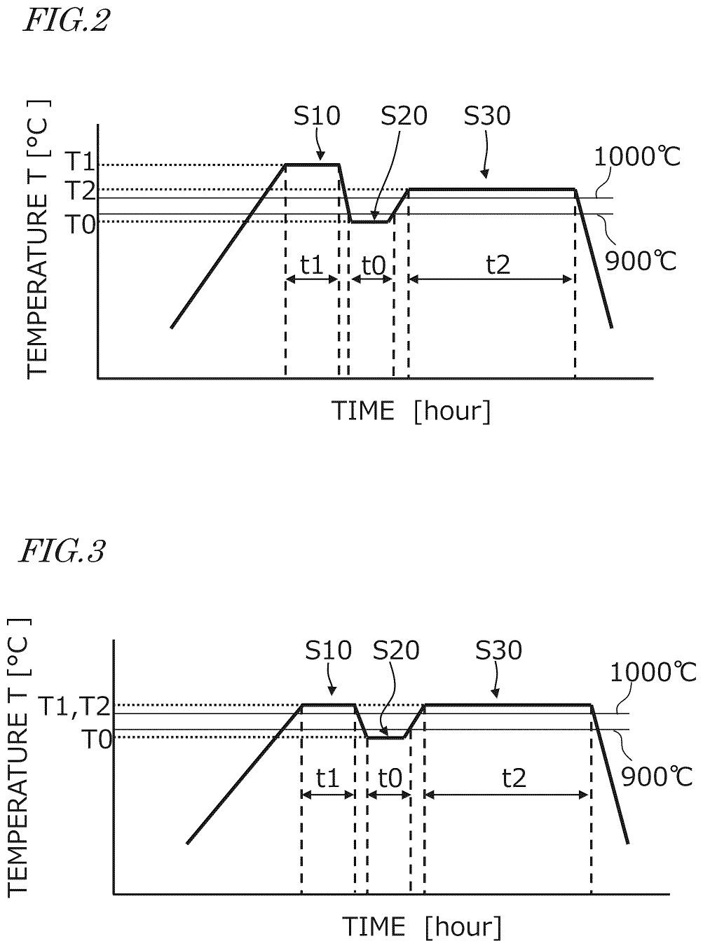

Now, with reference to FIG. 2 through FIG. 5, examples of the steps S10, S20 and S30 mentioned above will be described in more detail. These figures show graphs in which the horizontal axis represents the time and the vertical axis represents the temperature. The graphs schematically show examples of temperature profile of the heat treatment targets (compact and sintered body) in the sintering step. The temperature of such a heat treatment target is measured by a thermometer installed in a sintering device (sintering furnace), such as a thermocouple or the like. The actual temperature of the compact or the sintered body and the reading (measured temperature value) indicated by the thermometer in the sintering furnace do not need to be precisely equal to each other, and a tolerance of ±5° or less is permitted.

First, FIG. 2 will be referred to. In FIG. 2, the thick solid line represents the relationship between the temperature and the time. The time is an elapsed time from the start of the sintering step. The unit of the elapsed time is, for example, hour, but alternatively, may be minute or second. The temperature is a temperature value measured by the thermometer as described above, but is substantially equal to a set temperature designated by a temperature control program. In the figure, the thick solid line is formed of straight line segments, but the actual temperature or the set temperature may change in a curve.

In the example shown in FIG. 2, the temperature of the treatment target (compact) increases monotonously from room temperature to the first sintering temperature T1, and the temperature rise rate is constant. However, the temperature rise rate does not need to be constant, and there may be a period in the middle where the temperature rise rate is zero. In order to allow a lubricant, hydrogen (at the time of hydrogen pulverization), or an oily material such as a slurry or the like contained in the compact to be vaporized, the temperature may be kept, for example, at about 200° C. for a time that is not shorter than 1 hour and not longer than 10 hours.

The graphs in the figures each show horizontal straight lines representing temperatures of 900° C. and 1000° C. In a preferred embodiment, each of the first sintering temperature T1 and the second sintering temperature T2 is not lower than 1000° C. and not higher than 1100° C. In the example shown in FIG. 2, the first sintering temperature T1 is higher than the second sintering temperature T2. Alternatively, as shown in FIG. 3, the first sintering temperature T1 and the second sintering temperature T2 may be equal to each other. In a preferred embodiment, the first sintering temperature T1 is, for example, not lower than 1040° C. and lower than 1080° C., and the second sintering temperature T2 is, for example, not lower than 1020° C. and lower than 1060° C.

In an embodiment, the first sintering time t1 is not shorter than 30 minutes and not longer than 2 hours, and the second sintering time t2 is not shorter than 1 hour and not longer than 15 hours. According to the present disclosure, a sintered magnet having high H_{cJ} and high Hₖ/H_{cJ} is provided without the sintering being performed for a long time. Therefore, preferably, the first sintering time t1 is not shorter than 30 minutes and not longer than 1 hour, and the second sintering time t2 is not shorter than 1 hour and not longer than 8 hours. In particular, in the case where, as shown in FIG. 2, the first sintering temperature T1 is higher than the second sintering temperature T2, it is preferred that the first sintering time t1 is shorter than the second sintering time t2. In this case, it is preferred that, for example, the first sintering time t1 is not longer than a half of the second sintering time t2.

In this embodiment, the cooling step (S20) of decreasing the temperature of the first-stage sintered body to the cooling temperature T0 is performed between the first-stage step (S10) and the second-stage step (S30). In the present disclosure, a time t0, in the cooling step, in which the temperature of the treatment target (first-stage sintered body) is not higher than 900° C. is defined as a “cooling time”. Therefore, the cooling time t0 includes a temperature drop time and a transition time. The temperature drop time is a time period required for the temperature, while decreasing from the first sintering temperature T1, to decrease from 900° C. to the cooling temperature T0. The transition time is a time period required for the temperature, while increasing from the cooling temperature T0, to increase from the cooling temperature T0 to 900° C. It is preferred that the first sintering temperature T1 and the cooling temperature t0 are different from each other by 50° C. or more. That is, it is preferred that the cooling temperature t0 is lower by 50° C. or more than the first sintering temperature T1. T0 is made lower by 50° C. or more than T1, so that a sintered magnet having high H_{cJ} and high Hₖ/H_{cJ} may be provided certainty.

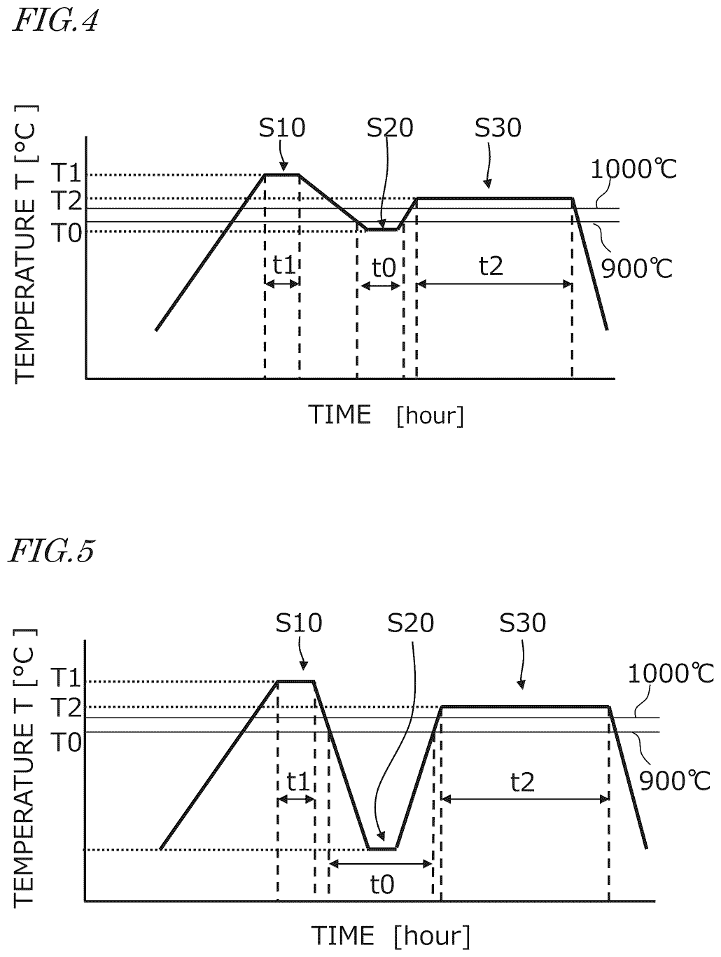

As shown in FIG. 4, the temperature drop rate during the cooling may be less than that in the example shown in FIG. 2. However, according to experiments performed by the present inventors, the magnetic characteristics do not depend much on the temperature drop rate during the cooling. Therefore, from the point of view of shortening the time necessary for the sintering step and thus improving the mass-productivity, the temperature drop rate is preferably not less than 3° C./min., and more preferably not less than 20° C./min.

The cooling temperature T0, which is not higher than 900° C., may be in the range that is not lower than 700° C. and not higher than 900° C., or at the level of room temperature as shown in FIG. 5. From the point of view of shortening the time necessary for the cooling step and thus improving the mass-productivity, the cooling temperature T0 may be set in the range that is, for example, not lower than 800° C. and not higher than 900° C.

<Sintered R-T-B Based Magnet>

R is a rare-earth element and contains at least one selected from the group consisting of Nd, Pr and Ce with no exception. Preferably, a combination of rare-earth elements represented by Nd—Dy, Nd—Tb, Nd—Dy—Tb, Nd—Pr—Dy, Nd—Pr—Tb, or Nd—Pr—Dy—Tb is used.

Among the elements that may be contained in R, Dy and Tb are especially effective to improve the H_{cJ}. In addition to the above-listed elements, La or any other rare-earth element is usable. Alternatively, misch metal or didymium may be used. R does not need to be a pure element, and may contain impurities unavoidably mixed during the production, in an amount of an industrially available range. R is contained at a content of, for example, not lower than 27% by mass and not higher than 35% by mass. The R content in the sintered R-T-B based magnet is preferably not higher than 31% by mass (not lower than 27% by mass and not higher than 31% by mass, and preferably not lower than 29% by mass and not higher than 31% by mass). The R content in the sintered R-T-B based magnet is set to a level that is not higher than 31% by mass and a content of oxygen therein is set to a level that is not lower than 400 ppm and not higher than 4000 ppm (preferably, not lower than 400 ppm and not higher than 2500 ppm, and more preferably, not lower than 400 ppm and not higher than 2000 ppm), so that the generation of oxidized R is alleviated. Therefore, higher magnetic characteristics are obtained.

T contains iron (a case where T is substantially formed of iron is encompassed), and at most 50% by mass of the iron may be replaced with cobalt (Co) (a case where T is substantially formed of iron and cobalt is encompassed). Co is effective to improve the temperature characteristics and the corrosion resistance. The alloy powder may contain cobalt at a content of not higher than 10% by mass. A content of T may be a part other than R and B, or a part other than R, B and M described below.

A content of B may be a known content, and is preferably, for example, 0.8% by mass to 1.2% by mass. If the B content is lower than 0.8% by mass, high H_{cJ} may not be obtained. If the B content is higher than 1.2% by mass, the Bᵣ may be decreased. A part of B may be replaced with C (carbon).

In addition to the above-listed elements, an M element may be incorporated in order to improve the H_{cJ}. The M element is at least one selected from the group consisting of Al, Si, Ti, V, Cr, Mn, Ni, Cu, Zn, Ga, Zr, Nb, Mo, In, Sn, Hf, Ta and W. A content of the M element is preferably not higher than 5.0% by mass. A reason for this is that if the M content is higher than 5.0% by mass, the Bᵣ may be decreased. Unavoidable impurities may be contained.

A content of N (nitrogen) in the sintered R-T-B based magnet is preferably not lower than 50 ppm and not higher than 600 ppm. Pulverization is performed such that the N (nitrogen) content is not lower than 50 ppm and not higher than 600 ppm, so that the deterioration in the magnetic characteristics caused by the nitriding is suppressed while the ease of pulverization is improved. The nitrogen content is more preferably not lower than 50 ppm and not higher than 400 ppm, and most preferably not lower than 100 ppm and not higher than 300 ppm. A reason for this is that with such a range of nitrogen content, the deterioration in the magnetic characteristics caused by the nitriding is suppressed while the ease of pulverization is further improved. A content of C (carbon) in the sintered R-T-B based magnet is preferably not lower than 50 ppm and not higher than 1300 ppm.

An example of composition of the sintered R-T-B based magnet in this embodiment will be shown below.

The sintered R-T-B based magnet contains R, B and T at the following contents:
R: not lower than 28% by mass and not higher than 35% by mass,
B: not lower than 0.8% by mass and not higher than 1.2% by mass, and
T: not lower than 61.5% by mass.
   Where [B] is the content of B as represented with “% by mass”, and [T] is the content of T as represented with “% by mass”, the sintered R-T-B based magnet satisfies:

14[B]/10.8<[T]/55.85 expression 1

Expression 1, i.e., 14[B]/10.8<[T]/55.85 is satisfied, so that the content of B is lower than that in a general sintered R-T-B based magnet. In a general sintered R-T-B based magnet, [T]/55.85 (atomic weight of Fe) is lower than 14[B]/10.8 (atomic weight of B) so that an R₂T₁₇ phase, which is a soft magnetic phase, is not generated.

<Example of Step (1) of Preparing a Coarse-Pulverized Powder of an Alloy for the Sintered R-T-B Based Magnet>

The step of preparing a coarse-pulverized powder of an alloy for the sintered R-T-B based magnet in this embodiment includes a step of preparing an alloy for the sintered R-T-B based magnet and a step of coarse-pulverizing the alloy by, for example, a hydrogen pulverization method or the like.

Hereinafter, a method for producing an alloy for the sintered R-T-B based magnet will be described.

First, a metal material or an alloy adjusted in advance so as to have the above-described composition is subjected to an ingot casting method, namely, is melted and put into a casting mold. As a result, an alloy ingot is obtained. Alternatively, a molten metal material or alloy may be subjected to a quenching method, for example, a strip casting method or a centrifugal casting method. As a result, an alloy flake is produced. According to the strip casting method or the centrifugal casting method, the molten metal material or alloy is put into contact with a monoaxial roll, a biaxial roll, a rotatable disc, a rotatable cylindrical casting mold or the like and quenched, and as a result, a coagulated alloy thinner than an alloy produced by an ingot method is produced.

In an embodiment of the present disclosure, the alloy produced by either the ingot method or the quenching method is usable. It is preferred that the alloy is produced by the quenching method such as the strip casting method or the like. A quenched alloy produced by such a quenching method usually has a thickness in the range of 0.03 mm to 1 mm, and is flake-shaped. The molten alloy starts coagulating from a surface that is in contact with the cooling roll (roll contact surface), and crystal grows like columns in a thickness direction from the roll contact surface. The quenched alloy is formed by cooling performed in a shorter time than an alloy (ingot alloy) produced by the conventional ingot casting method (mold casting method), and therefore, includes a finer texture, has a shorter crystal grain size, and a larger area size of grain boundaries. An R-rich phase expands broadly in the grain boundaries. Therefore, the R-rich phase in the alloy produced by the quenching method is highly dispersed. For this reason, the alloy is easily broken at the grain boundaries by the hydrogen pulverization method. The quenched alloy is pulverized by the hydrogen pulverization method, so that the size (average particle size) of the hydrogen-pulverized powder (coarse-pulverized powder) may be, for example, not longer than 1.0 mm, preferably, not shorter than 10 μm and not longer than 500 μm.

<Example of Step (2) of Obtaining a Fine-Pulverized Powder>

In the step of obtaining a fine-pulverized powder in this embodiment, the coarse-pulverized powder is provided to a jet mill machine including a pulverization chamber filled with inert gas, and is pulverized, to obtain a fine-pulverized powder. In this step, a fine-pulverized powder (R-T-B based alloy powder) having an average particle size that is, for example, not shorter than 2.0 μm and not longer than 4.5 μm is obtained. The step of obtaining such a fine-pulverized powder may be performed by use of, for example, a jet mill pulverization system.

In the step of obtaining the fine-pulverized powder and subsequent steps (mainly, a step of forming a sintered body of the fine-pulverized powder), the content of oxygen in the sintered R-T-B based magnet is increased by, preferably, a level not lower than 50 ppm and not higher than 300 ppm, and more preferably, a level not lower than 50 ppm and not higher than 200 ppm. In order to realize such an increase, it is preferred that magnetic field wet press or magnetic field press in an inert gas atmosphere is performed as described below, and the obtained compact is sintered. The fine-pulverized powder obtained in the step of obtaining the fine-pulverized powder preferably has an average particle size of not shorter than 2.0 μm and not longer than 4.5 μm. The average particle size is made shorter, so that the magnetic characteristics may be improved.

<Example of Step (3) of Forming a Compact of the Fine-Pulverized Powder>

Regarding the magnetic field press performed in the step of forming a compact, it is preferred to perform the press in an inert gas atmosphere or the wet press to form a compact, from the point of view of suppressing oxidation. Especially in the case where the wet press is performed, surfaces of particles forming the compact are covered with a dispersant such as an oily material or the like, and thus are suppressed from contacting oxygen or water vapor in the air. Therefore, the particles are prevented or suppressed from being oxidized by the air before, during and after the pressing step.

In order to perform the magnetic field wet press, a slurry containing a dispersant mixed in the fine-pulverized powder is prepared and is supplied to a cavity of a die of a wet pressing apparatus. Thus, the slurry is pressed in the magnetic field.

Dispersant

A dispersant is a liquid that forms a slurry by having an alloy powder dispersed therein.

A dispersant preferably usable for the present disclosure may be mineral oil or synthetic oil. There is no specific limitation on the type of the mineral oil or the synthetic oil. If the mineral oil or the synthetic oil has a kinetic viscosity larger than 10 cSt at room temperature, such an increased viscosity strengthens the binding force between the alloy powder particles and may have an adverse influence on the ease of alignment of the alloy powder during the magnetic field wet press. Therefore, the kinetic viscosity of the mineral oil or the synthetic oil at room temperature is preferably not higher than 10 cSt. If the mineral oil or the synthetic oil has a fractional distillation point higher than 400° C., it is difficult to deoil the obtained compact. As a result, the amount of carbon remaining in the sintered body may be increased to deteriorate the magnetic characteristics. Therefore, the fractional distillation point of the mineral oil or the synthetic oil is preferably not higher than 400° C. Vegetable oil may be used as the dispersant. The “vegetable oil” refers to oil extracted from a plant, and there is no specific limitation on the type of the plant.

Formation of the Slurry

The slurry is obtained by mixing the obtained alloy powder and the dispersant.

There is no specific limitation on the mixing ratio of the alloy powder and the dispersant. It is preferred that the slurry contains the alloy powder at a concentration that is not lower than 70% on the mass basis (i.e., not lower than 70% by mass), for the following reasons. With such a concentration range, the alloy powder is supplied into the cavity efficiently at a flow rate of 20 to 600 cm³/sec., and superb magnetic characteristics are obtained. Preferably, the concentration of the alloy powder in the slurry is not higher than 90% by mass. There is no specific limitation on the method of mixing the alloy powder and the dispersant. The alloy powder and the dispersant may be separately prepared and mixed with respective predetermined weights to form a slurry. Alternatively, the slurry may be formed as follows: in the process of dry-pulverizing the coarse-pulverized powder by a jet mill or the like to obtain the alloy powder, a container accommodating a dispersant is located at an alloy powder outlet of a pulverization machine such as the jet mill or the like, and the alloy powder obtained as a result of the pulverization is directly recovered into the dispersant in the container. Thus, a slurry is formed. In this case, it is preferred that the container is provided with an atmosphere formed of nitrogen gas and/or argon gas, so that the obtained alloy powder is directly recovered into the dispersant without contacting the air to form the slurry. Still alternatively, the coarse-pulverized powder may be wet-pulverized by a vibration mill, a ball mill, an attritor or the like while being held in the dispersant. Thus, a slurry is formed of the alloy powder and the dispersant.

The slurry obtained in such a manner is pressed by a known wet pressing apparatus to obtain a compact having a predetermined size and a predetermined shape. The obtained compact is sintered to obtain a sintered body.

<Example of (4) Sintering Step>

Next, the compact is sintered to obtain a sintered body. As described above, the sintering step in this embodiment includes:
the first-stage step (S10) of heating the compact to the first sintering temperature T1 to form the first-stage sintered body;
the cooling step (S20) of cooling the first-stage sintered body to the cooling temperature T0; and
the second-stage step (S30) of heating the first-stage sintered body to the second sintering temperature T2 to form the second-stage sintered body.

The compact may be sintered by use of vacuum or inert gas such as helium, argon or the like.

It is preferred that the obtained sintered body is heat-treated. The heat treatment improves the magnetic characteristics. The conditions for the heat treatment, such as the heat treatment temperature, the heat treatment time and the like, may be known conditions. For example, the sintered body is heat-treated at a temperature that is not higher than the first sintering temperature T1 or the second sintering temperature T2 (e.g., 400° C. to 800° C.) for a time not shorter than 1 hour. The sintered R-T-B based magnet obtained in this manner is subjected to a grinding and/or polishing step, a surface treatment step, and a magnetization step as necessary. Thus, a sintered R-T-B based magnet is obtained as a final product.

In a preferred embodiment, the method for producing a sintered R-T-B based magnet according to the present disclosure includes a diffusion step of diffusing a heavy rare-earth element RH (RH is at least one of Tb, Dy and Ho) from the surface to the interior of the sintered body. Diffusion of the heavy rare-earth element RH from the surface to the interior of the sintered body efficiently improves the coercivity.

### EXAMPLES

The present disclosure will be described in more detail by way of examples, but the present disclosure is not limited thereto.

### Experiment 1

The elements were weighed such that sintered R-T-B based magnets would generally have the composition of No. 1 shown in Table 1 and cast by a strip casting method to obtain a flake-like alloy. The obtained flake-like alloy was hydrogen-embrittled in a hydrogen-pressurized atmosphere, and then dehydrogenated, namely, was heated and cooled in vacuum, to obtain a coarse-pulverized powder. Next, the obtained coarse-pulverized powder was pulverized by use of a jet mill machine to obtain an alloy powder having a D₅₀ of 3.6 μm.

A lubricant was incorporated into the alloy powder at a ratio of 0.4% by mass with respect to 100% by mass of the alloy powder, and mixed therewith. The mixture was pressed in a magnetic field to obtain a compact. As a pressing apparatus, a so-called orthogonal magnetic field pressing apparatus (transverse magnetic field pressing apparatus) was used, in which the direction of magnetic field application was orthogonal to the pressurizing direction.

The obtained compact was sintered under the conditions shown in Table 2. In Table 2, No. 1-4 was obtained as follows. The compact formed so as to have the composition of No. 1 in Table 1 was heated at 1050° C. as the first sintering temperature T1 for 0.5 hours (30 minutes) as the first sintering time t1 to form a first sintered body (first-stage step), the first sintered body was quenched to room temperature (about 30° C.) as the cooling temperature T0 (at a rate of 10° C./min. or more), and the post-cooling first sintered body was heated at 1040° C. as the second sintering temperature for 4 hours as the second sintering time t2 to form a second sintered body (second-stage step). The conditions for forming the other samples are represented in the same manner. For forming No. 1-1 through No. 1-3 as comparative examples, the sintering step was performed only once. The post-sintering sintered R-T-B based magnets were each heat-treated; specifically, kept at 900° C. for 2 hours, then cooled to room temperature, kept at 500° C. for 2 hours, and then cooled to room temperature. As a result, sintered R-T-B based magnets (No. 1-1 through No. 1-9) were obtained.

The components of the obtained sintered R-T-B based magnets are shown in Table 1. A sum of the amounts of the components in Table 1, oxygen and carbon is not 100% by mass. A reason for this is that the sintered R-T-B based magnets contain elements as impurities that are not shown in the table. This is also applicable to the other tables. In the tables, “◯” indicates that expression 1 is satisfied, and “x” indicates that expression 1 is not satisfied. The sintered R-T-B based magnets were each mechanically processed to produce a sample having a length of 7 mm, a width of 7 mm and a thickness of 7 mm. The samples were measured by a B-H tracer to find the magnetic characteristics. Regarding the second orthant of a J (intensity of magnetization)−H (intensity of the magnetic field) curve, Hₖ is defined as the reading on the H axis at a position where J has a value of 0.9×Jᵣ (Jᵣ is the residual magnetization; Jᵣ=Bᵣ). The ratio of the Hₖ with respect to the H_{cJ} of the demagnetization curve, i.e., Hₖ/H_{cJ} was found by Hₖ(kA/m)/H_{cJ}(kA/m)×100(%). The results are shown in Table 3.

TABLE 1

| | COMPOSITION OF SINTERED R-T-B BASED MAGNET (% BY MASS) | | | | | | | | | | | | | |
|---|---|---|---|---|---|---|---|---|---|---|---|---|---|---|
| No. | Fe | Nd | Pr | Tb | B | Co | Al | Cu | Ga | Zr | O | N | C | EXPRESSION 1 |
| 1 | 66.3 | 22.6 | 7.3 | 0.0 | 0.86 | 0.87 | 0.10 | 0.14 | 0.53 | 0.10 | 0.11 | 0.08 | 0.11 | ∘ |

TABLE 2

| | | | | | COOLING | | | |
|---|---|---|---|---|---|---|---|---|
| No. | COMPOSITION | T1 (° C.) | t1(hr) | T0(° C.) | RATE | T2(° C.) | t2(hr) | REMARKS |
| 1-1 | 1 | 1030 | 4 | ROOM | QUENCH | — | — | COMPARATIVE |
| | | | | TEMPERATURE | | | | EXMPLE |
| 1-2 | 1 | 1040 | 4 | ROOM | QUENCH | — | — | COMPARATIVE |
| | | | | TEMPERATURE | | | | EXMPLE |
| 1-3 | 1 | 1050 | 4 | ROOM | QUENCH | — | — | COMPARATIVE |
| | | | | TEMPERATURE | | | | EXMPLE |
| 1-4 | 1 | 1050 | 0.5 | ROOM | QUENCH | 1040 | 4 | PRESENT |
| | | | | TEMPERATURE | | | | INVENTION |
| 1-5 | 1 | 1050 | 0.5 | 700 | 7° C./min. | 1040 | 4 | PRESENT |
| | | | | | | | | INVENTION |
| 1-6 | 1 | 1050 | 0.5 | 900 | 7° C./min. | 1040 | 4 | PRESENT |
| | | | | | | | | INVENTION |
| 1-7 | 1 | 1040 | 0.5 | ROOM | QUENCH | 1030 | 4 | PRESENT |
| | | | | TEMPERATURE | | | | INVENTION |
| 1-8 | 1 | 1040 | 0.5 | ROOM | QUENCH | 1050 | 4 | PRESENT |
| | | | | TEMPERATURE | | | | INVENTION |
| 1-9 | 1 | 1060 | 0.5 | ROOM | QUENCH | 1020 | 4 | PRESENT |
| | | | | TEMPERATURE | | | | INVENTION |

TABLE 3

| No. | Br[T] | HcJ[kA/m] | Hk[kA/m] | Hk/HcJ[%] | REMARKS |
|---|---|---|---|---|---|
| 1-1 | 1.379 | 1589 | 1417 | 89.1 | COMPARATIVE |
| | | | | | EXMPLE |
| 1-2 | 1.382 | 1636 | 1435 | 87.7 | COMPARATIVE |
| | | | | | EXMPLE |
| 1-3 | ABNORMAL GRAIN GROWTH OCCURS | | | | COMPARATIVE |
| | | | | | EXMPLE |
| 1-4 | 1.390 | 1646 | 1509 | 91.7 | PRESENT |
| | | | | | INVENTION |
| 1-5 | 1.385 | 1654 | 1516 | 91.6 | PRESENT |
| | | | | | INVENTION |
| 1-6 | 1.378 | 1649 | 1507 | 91.4 | PRESENT |
| | | | | | INVENTION |
| 1-7 | 1.387 | 1656 | 1492 | 90.1 | PRESENT |
| | | | | | INVENTION |
| 1-8 | 1.388 | 1660 | 1524 | 91.9 | PRESENT |
| | | | | | INVENTION |
| 1-9 | 1.387 | 1647 | 1487 | 90.3 | PRESENT |
| | | | | | INVENTION |

As shown in Table 3, the sintered R-T-B based magnets in the examples of the present invention each have H_{cJ} 1646 kA/m and Hₖ/H_{cJ}≥90.1%. As can be seen, the sintered R-T-B based magnets have higher H_{cJ} and higher Hₖ/H_{cJ} than those of the comparative examples. Regarding the comparative examples (No. 1-1 through No. 1-3), when the sintering temperature is changed to the range of 1030° C. to 1050° C., the H_{cJ} is significantly decreased (No. 1-1) or the coarse grains are generated (No. 1-3). Therefore, the magnetic characteristics may possibly be decreased unexpectedly due to dispersion in the production conditions. By contrast, the sintered R-T-B based magnets in the present invention examples all have high H_{cJ} and high Hₖ/H_{cJ} even when the sintering temperatures (T1 and T2) change. The sintering time of the present invention examples and the sintering time of the comparative examples are different from each other by about 0.5 hours, that is, are not much different. As can be seen, in the present invention examples, the sintered R-T-B based magnets having high H_{cJ} and high Hₖ/H_{cJ} are obtained without the sintering being performed for a long time.

Experiment 2

Compacts were formed in substantially the same manner as in experiment 1 except that the elements were weighed such that sintered R-T-B based magnets would have the compositions of No. 2 through No. 4 in Table 4. The obtained compacts were sintered under the conditions shown in Table 5. The post-sintering sintered R-T-B based magnets were heat-treated in the same manner as in experiment 1 to obtain sintered R-T-B based magnets (No. 2-1 through No. 2-6).

The components of the obtained sintered R-T-B based magnets are shown in Tables 4. As shown in Tables 4 and 5, No. 2-1 and No. 2-2 each have the composition of No. 2 in Table 4, No. 2-3 and No. 2-4 each have the composition of No. 3 in Table 4, and No. 2-5 and No. 2-6 each have the composition of No. 4 in Table 4. The magnetic characteristics and the Hₖ/H_{cJ} of the obtained sintered R-T-B based magnets were found in the same manner as in experiment 1. The results are shown in Table 6.

TABLE 4

| | COMPOSITION OF SINTERED R-T-B BASED MAGNET | | | | | | | | | | | | | |
|---|---|---|---|---|---|---|---|---|---|---|---|---|---|---|
| No. | Fe | Nd | Pr | Tb | B | Co | Al | Cu | Ga | Zr | O | N | C | EXPRESSION 1 |
| 2 | 67.6 | 20.9 | 7.8 | 0.9 | 0.95 | 0.50 | 0.09 | 0.14 | 0.48 | 0.09 | 0.12 | 0.02 | 0.10 | x |
| 3 | 67.6 | 20.9 | 7.8 | 0.9 | 0.93 | 0.50 | 0.09 | 0.13 | 0.48 | 0.09 | 0.12 | 0.03 | 0.10 | ∘ |
| 4 | 67.5 | 20.8 | 7.8 | 0.9 | 0.91 | 0.50 | 0.10 | 0.13 | 0.48 | 0.08 | 0.13 | 0.03 | 0.10 | ∘ |

TABLE 5

| | | | | | COOLING | | | |
|---|---|---|---|---|---|---|---|---|
| No. | COMPOSITION | T1 (° C.) | t1(hr) | T0(° C.) | RATE | T2(° C.) | t2(hr) | REMARKS |
| 2-1 | 2 | 1020 | 4 | ROOM | QUENCH | — | — | COMPARATIVE |
| | | | | TEMPERATURE | | | | EXMPLE |
| 2-2 | 2 | 1030 | 0.5 | 700 | 7° C./min. | 1020 | 4 | PRESENT |
| | | | | | | | | INVENTION |
| 2-3 | 3 | 1020 | 4 | ROOM | QUENCH | — | — | COMPARATIVE |
| | | | | TEMPERATURE | | | | EXMPLE |
| 2-4 | 3 | 1030 | 0.5 | 700 | 7° C./min. | 1020 | 4 | PRESENT |
| | | | | | | | | INVENTION |
| 2-5 | 4 | 1020 | 4 | ROOM | QUENCH | — | — | COMPARATIVE |
| | | | | TEMPERATURE | | | | EXMPLE |
| 2-6 | 4 | 1030 | 0.5 | 700 | 7° C./min. | 1020 | 4 | PRESENT |
| | | | | | | | | INVENTION |

TABLE 6

| No. | Br[T] | HcJ[kA/m] | Hk[kA/m] | Hk/HcJ[%] | REMARKS |
|---|---|---|---|---|---|
| 2-1 | 1.413 | 1604 | 1505 | 93.8 | COMPARATIVE |
| | | | | | EXMPLE |
| 2-2 | 1.419 | 1620 | 1521 | 93.9 | PRESENT |
| | | | | | INVENTION |
| 2-3 | 1.413 | 1631 | 1494 | 91.6 | COMPARATIVE |
| | | | | | EXMPLE |
| 2-4 | 1.416 | 1677 | 1561 | 93.1 | PRESENT |
| | | | | | INVENTION |
| 2-5 | 1.404 | 1794 | 1426 | 79.5 | COMPARATIVE |
| | | | | | EXMPLE |
| 2-6 | 1.401 | 1853 | 1600 | 86.3 | PRESENT |
| | | | | | INVENTION |

As shown in Table 6, the sintered R-T-B based magnets in the present invention examples all have higher H_{cJ} and higher Hₖ/H_{cJ} than those of the comparative examples (No. 2-1, No. 2-2 and No. 2-3 are compared respectively against No. 2-4, No. 2-5 and No. 2-6).

Experiment 3

Compacts were formed in substantially the same manner as in experiment 1 except that the elements were weighed such that sintered R-T-B based magnets would have the composition of No. 5 shown in Table 7. The obtained compact was sintered under the conditions shown in Table 8. The components of the obtained sintered R-T-B based magnets are shown in Tables 7. The obtained sintered R-T-B based magnets were subjected to the diffusion step. Specifically, atomized powder (not longer than 106 μm) containing Nd at a content of 0.3% by mass, Pr at a content of 76.4% by mass, Tb at a content of 13.4% by mass, Cu at a content of 4.7% by mass, and Ga at a content of 5.2% by mass was prepared. Next, the entire surface of each of the sintered R-T-B based magnets was coated with a pressure-sensitive adhesive containing sugar alcohol by a dipping method. The atomized powder was attached to each of the sintered R-T-B based magnets coated with the pressure-sensitive adhesive at a ratio of 2% by mass with respect to the mass of the sintered R-T-B based magnet. Then, the sintered R-T-B based magnets with the atomized powder were heated at 920° C. for 10 hours in a heat treatment furnace to perform the diffusion step, and then cooled. After this, the obtained sintered R-T-B based magnets were heat-treated at 480° C. for 3 hours in a heat treatment furnace. The magnetic characteristics and Hₖ/H_{cJ} of the obtained post-diffusion sintered R-T-B based magnets were found in the same manner as in experiment 1. The results are shown in Table 9.

TABLE 7

| | COMPOSITION OF SINTERED R-T-B BASED MAGNET | | | | | | | | | | | | | |
|---|---|---|---|---|---|---|---|---|---|---|---|---|---|---|
| No. | Fe | Nd | Pr | Tb | B | Co | Al | Cu | Ga | Zr | O | N | C | EXPRESSION 1 |
| 5 | 68.0 | 23.9 | 5.4 | 0.0 | 0.94 | 0.43 | 0.08 | 0.29 | 0.41 | 0.05 | 0.17 | 0.02 | 0.12 | ∘ |

TABLE 8

| | | | | | COOLING | | | |
|---|---|---|---|---|---|---|---|---|
| No. | COMPOSITION | T1 (° C.) | t1(hr) | T0(° C.) | RATE | T2(° C.) | t2(hr) | REMARKS |
| 3-1 | 5 | 1040 | 4 | ROOM | QUENCH | — | — | COMPARATIVE |
| | | | | TEMPERATURE | | | | EXMPLE |
| 3-2 | 5 | 1010 | 0.5 | ROOM | QUENCH | 1020 | 4 | PRESENT |
| | | | | TEMPERATURE | | | | INVENTION |
| 3-3 | 5 | 1050 | 0.5 | ROOM | QUENCH | 1020 | 4 | PRESENT |
| | | | | TEMPERATURE | | | | INVENTION |
| 3-4 | 5 | 1055 | 0.5 | 400 | QUENCH | 1035 | 2 | PRESENT |
| | | | | | | | | INVENTION |

TABLE 9

| No. | Br[T] | HcJ[kA/m] | Hk[kA/m] | Hk/HcJ[%] | REMARKS |
|---|---|---|---|---|---|
| 3-1 | 1.436 | 1861 | 1668 | 89.6 | COMPARATIVE |
| | | | | | EXMPLE |
| 3-2 | 1.437 | 1873 | 1684 | 89.9 | PRESENT |
| | | | | | INVENTION |
| 3-3 | 1.440 | 1896 | 1710 | 90.2 | PRESENT |
| | | | | | INVENTION |
| 3-4 | 1.450 | 1886 | 1687 | 89.4 | PRESENT |
| | | | | | INVENTION |

As shown in Table 9, the sintered R-T-B based magnets in the present invention examples have higher H. J and higher Hₖ/H_{cJ} than those of the comparative examples.

### INDUSTRIAL APPLICABILITY

A method for producing a sintered R-T-B based magnet according to the present disclosure is applicable for a permanent magnet usable for various uses including various types of motors such as voice coil motors (VCM) of hard disc drives, motors for electric vehicles (EV, HV, PHV) and motors for industrial equipment, home appliance products, and the like.

1: A method for producing a sintered R-T-B based magnet, the method comprising:
a sintering step of sintering a compact of an R-T-B based alloy powder (R is a rare-earth element and contains at least one selected from the group consisting of Nd, Pr and Ce with no exception, T is at least one transition metal and contains Fe with no exception, and B is boron),
wherein the sintering step includes:
a first-stage step of heating the compact to a first sintering temperature T1 to form a first-stage sintered body,
a cooling step of decreasing the temperature of the first-stage sintered body to a cooling temperature T0, and
a second-stage step of heating the first-stage sintered body to a second sintering temperature T2 to form a second-stage sintered body,
wherein the first sintering temperature T1 and the second sintering temperature T2 are higher than 900° C.,
wherein the cooling temperature T0 is not higher than 900° C., and
wherein a first sintering time t1, for which the first sintering temperature T1 is maintained in the first-stage step, is shorter than a second sintering time t2, for which the second sintering temperature T2 is maintained in the second-stage step.

2: The method for producing a sintered R-T-B based magnet of claim 1, wherein the first sintering temperature T1 and the second sintering temperature T2 are not lower than 1000° C. and not higher than 1100° C.

3: The method for producing a sintered R-T-B based magnet of claim 1, wherein the first sintering temperature T1 is not lower than 1040° C. and lower than 1080° C., and the second sintering temperature T2 is not lower than 1020° C. and lower than 1060° C.

4: The method for producing a sintered R-T-B based magnet of claim 1, wherein the first sintering time t1 is not shorter than 30 minutes and not longer than 2 hours, and the second sintering time t2 is not shorter than 1 hour and not longer than 15 hours.

5: The method for producing a sintered R-T-B based magnet of claim 1, wherein the first sintering time t1 is not longer than a half of the second sintering time t2.

6: The method for producing a sintered R-T-B based magnet of claim 1, wherein the cooling temperature T0 is not lower than 700° C. and is not higher than 900° C.

7: The method for producing a sintered R-T-B based magnet of claim 1, wherein the alloy powder has a composition containing R at a content not lower than 28% by mass and not higher than 35% by mass, B at a content not lower than 0.8% by mass and not higher than 1.20% by mass, T at a content not lower than 61.5% by mass, and satisfying 14[B]/10.8<[T]/55.85 where [B] is a content of B represented with % by mass and [T] is a content of T represented with % by mass.
